(19) United States
(12) Patent Application Publication
(10) Pub. No.: US 2023/0145609 A1
(43) Pub. Date: May 11, 2023

(54) METHODS FOR MANUFACTURING COMPOSITE SOLID-STATE ELECTROLYTE MEMBRANES AND SOLID-STATE BATTERIES COMPRISING THE SAME

(71) Applicant: Ampcera Inc., Milpitas, CA (US)

(72) Inventors: James Emery Brown, Tucson, AZ (US); Hui Du, Tucson, AZ (US); Sumin Zhu, San Diego, CA (US)

(21) Appl. No.: 17/966,327

(22) Filed: Oct. 14, 2022

Related U.S. Application Data
(60) Provisional application No. 63/255,931, filed on Oct. 14, 2021.

(51) Int. Cl. H01M 10/056; H01M 4/04

(52) U.S. Cl. CPC H01M 10/056; H01M 4/0411

(57) ABSTRACT

A composite solid-state electrolyte membrane is manufactured by a meltblown extrusion process. A solid-state battery and a method for manufacturing a solid-state battery includes the solid-state electrolyte membrane.

### PRIORITY

The present application claims the priority of U.S. Provisional Pat. Application No. 63/255,931, filed Oct. 14, 2021, which is incorporated herein by reference in its entirety.

### FIELD

The present description relates to the field of composite solid-state electrolyte membranes, solid state batteries comprising composite solid-state electrolyte membranes, and methods for manufacturing thereof.

### BACKGROUND

The scaled production of composite solid-state electrolyte membranes and their integration into the solid-state battery assembly remains a challenge.

Accordingly, those skilled in the art continue with research and development in the field of composite solid-state electrolyte membranes, solid-state batteries comprising composite solid-state electrolyte membranes, and methods for manufacturing thereof

### SUMMARY

In one embodiment, a method for manufacturing a composite solid-state electrolyte membrane includes forming the composite solid-state electrolyte membrane by meltblown extrusion. In an aspect, the forming of the composite solid-state electrolyte membrane by meltblown extrusion may include forming the composite solid-state electrolyte membrane by meltblown extrusion on a substrate and separating the composite solid-state electrolyte membrane from the substrate. The substrate can be, for example, a rotating collecting drum. In another aspect, the forming of the composite solid-state electrolyte membrane by meltblown extrusion may include forming the composite solid-state electrolyte membrane by meltblown extrusion on a solid-state battery electrode. In another aspect, the forming of the composite solid-state electrolyte membrane by meltblown extrusion may include forming the composite solid-state electrolyte membrane by meltblown extrusion on a support, which may be a fabric support. In another aspect, the forming of the composite solid-state electrolyte membrane by meltblown extrusion may include forming the composite solid-state electrolyte membrane by meltblown extrusion into a porous support, such as a fabric support.

In another embodiment, a method for manufacturing a solid state battery includes forming a composite solid-state electrolyte membrane by meltblown extrusion and positioning the composite solid-state electrolyte membrane between a positive current collector and a negative current collector. In an aspect, the method further includes forming an anode by meltblown extrusion with the composite solid-state electrolyte membrane. In another aspect, the method further includes forming a cathode by meltblown extrusion with the composite solid-state electrolyte membrane. In another aspect, the method further includes forming an anode and then assembling the anode with the composite solid-state electrolyte membrane into the solid state battery. In another aspect, the method further includes forming a cathode and then assembling the cathode with the composite solid-state electrolyte membrane into the solid-state battery.

In yet another embodiment, a solid state battery includes a positive current collector, a negative current collector, and a composite solid-state electrolyte membrane between the positive current collector and negative current collector, the composite solid-state electrolyte membrane having a meltblown structure. In an aspect, the solid-state battery further includes an anode between the negative current collector and the composite solid-state electrolyte membrane. The anode can have a meltblown structure. In another aspect, the solid-state battery further includes a cathode between the positive current collector and the composite solid-state electrolyte membrane. The cathode can have a meltblown structure.

Other embodiments of the disclosed methods for manufacturing a composite solid-state electrolyte membrane, methods for manufacturing a solid-state battery, and solid-state batteries comprising a composite solid-state electrolyte membrane will become apparent from the following detailed description, the accompanying drawings and the appended claims.

### BRIEF DESCRIPTION OF THE DRAWINGS

FIG. 1: A schematic illustration of an exemplary meltblown extrusion process for the manufacturing of freestanding composite solid-state electrolyte membranes.

FIG. 2: A schematic illustration of an exemplary meltblown extrusion process for the manufacturing of composite solid-state electrolyte membranes onto solid-state battery electrodes.

FIG. 3: A schematic illustration of a meltblown extrusion die and a collecting drum for an exemplary meltblown extrusion process.

FIG. 4: A schematic illustration of an exemplary solid-state battery.

FIG. 5: A schematic illustration of another exemplary solid-state battery.

FIG. 6: A schematic illustration of yet another exemplary solid-state battery

### DETAILED DESCRIPTION

The present description relates to composite solid-state electrolyte membranes and methods for manufacturing thereof, wherein freestanding composite membranes are manufactured using a meltblown extrusion process.

The present description also relates to composite solid-state electrolyte membranes and methods for manufacturing thereof, wherein composite membranes are manufactured onto solid-state battery electrodes using a meltblown extrusion process.

The present description also relates to a solid-state battery and methods for manufacturing thereof, the solid-state battery comprising of a composite cathode, a composite solid-state electrolyte membrane formed using a meltblown extrusion process, and either a composite anode or metal-based anode.

The present description also relates to an anodeless solid-state battery and methods for manufacturing thereof, the solid-state battery comprising of a composite cathode and a composite solid-state electrolyte membrane formed using a meltblown extrusion process.

In an aspect, the anode may also be formed using a meltblown extrusion process. In an aspect, the cathode may also be formed using a meltblown extrusion process.

The present description also relates to an all-meltblown solid-state battery and methods for manufacturing thereof, the all-meltblown solid-state battery comprising of a composite cathode, a composite anode, and a composite solid-state electrolyte membrane, wherein all three components are manufactured using a meltblown extrusion process.

The scaled production of composite solid-state electrolyte membranes and their integration in solid-state battery assembly remains a challenge. One method to overcome this challenge is to use meltblown processing to fabricate freestanding highly dense non-woven composite solid-state electrolyte membranes. These membranes can be directly integrated into solid-state battery assembly as a standalone component. Alternatively, the highly dense non-woven composite solid-state electrolyte membrane can be formed onto solid-state battery electrodes and directly integrated into solid-state battery assembly. In other instances, a solid-state battery may be assembled using active components all manufactured using a meltblown extrusion process.

In an embodiment, a dry composite solid-state electrolyte formulation may be used to form a composite solid-state electrolyte membrane.

In an aspect of the embodiment, a dry composite solid-state electrolyte formulation may be solvent-free.

In another aspect of the embodiment, a dry composite solid-state electrolyte formulation may be comprised of a solid-state ionic conductive material, a binding polymer, and an ionic conducting salt.

In yet another aspect of the embodiment, a solid-state ionic conducting material may have a room temperature ionic conductivity above 10⁻⁷ S cm⁻¹.

In yet another aspect of the embodiment, a dry composite solid-state electrolyte formulation may have a solid-state ionic conductive material weight percentage in the range of 0.01≤p≤99.99%.

In another embodiment, a meltblown extrusion process may be used to form a composite solid-state electrolyte membrane.

In an aspect of the embodiment, a dry solid-state electrolyte composite formulation may be extruded onto a collecting drum.

In another aspect of the embodiment, a composite solid-state electrolyte membrane may be in the form of a highly dense non-woven fibrous membrane network.

In yet another aspect of the embodiment, a meltblown extrusion die may control the architecture of the composite solid-state electrolyte membrane. For example, the diameters of the fibers making up the fibrous membrane network may be controlled by the diameter of the opening or openings of the meltblown extrusion die.

In yet another aspect of the embodiment, a meltblown extrusion process may have one or more meltblown extrusion dies, wherein the one or more meltblown extrusion dies may have one or more openings of varying diameters to enhance the density (i.e. reduce porosity) of the composite solid-state electrolyte membrane.

In yet another aspect of the embodiment, the one or more meltblown extrusion dies may remain stationary or move in a controlled automated process, wherein the one or more meltblown extrusion dies may move in the x-coordinate direction, y-coordinate direction, z-coordinate direction, all with respect to the collecting drum, or a combination thereof.

In yet another embodiment, a meltblown process may be used to form a freestanding composite solid-state electrolyte membrane.

In an aspect of the embodiment, a freestanding composite solid-state electrolyte membrane may be collected and used in downstream production of solid-state batteries as a standalone component.

In another aspect of the embodiment, a freestanding composite solid-state electrolyte membrane has a high degree of mechanical flexibility or mechanical strength allowing it to bend without macro- or micro-cracking.

In yet another aspect of the embodiment, a freestanding composite solid-state electrolyte membrane may have a room temperature ionic conductivity of ≥10⁻⁷ S/cm.

In yet another aspect of the embodiment, a freestanding composite solid-state electrolyte membrane may have a thickness is the range of 0.5≤t≤500 µm.

In yet another aspect of the embodiment, a freestanding composite solid-state electrolyte membrane may have a porosity in the range of 0.001≤p≤75%.

In yet another aspect of the embodiment, a freestanding composite solid-state electrolyte membrane may be formed onto, and into, a fabric support to enhance mechanical strength or serve as an internal heating element for the solid-state battery.

In yet another embodiment, a meltblown process may be used to form a composite solid-state electrolyte membrane onto a solid-state battery electrode.

In an aspect of the embodiment, a solid-state battery electrode may be rolled along a collecting drum, serving as a collecting surface of the extruded solid-state electrolyte composite formulation.

In another aspect of the embodiment, a solid-state battery electrode may include a composite cathode formed onto a positive current collector, such as aluminum foil.

In yet another aspect of the embodiment, a solid-state battery electrode may include a composite anode formed onto a negative current collector, such as copper foil.

In yet another aspect of the embodiment, a solid-state battery electrode may include a lithium metal-based anode formed onto a negative current collector, such as copper foil.

In yet another aspect of the embodiment, a negative current collector, such as copper foil, may be used as a collecting surface for the extruded solid-state electrolyte composite formulation.

In yet another aspect of the embodiment, a composite solid-state electrolyte membrane, formed onto a battery electrode, may have a room temperature ionic conductivity of ≥10⁻⁷ S/cm.

In yet another aspect of the embodiment, a composite solid-state electrolyte membrane, formed onto a battery electrode, may have a thickness is the range of 0.5≤t≤500 µm.

In yet another aspect of the embodiment, a composite solid-state electrolyte membrane, formed onto a battery electrode, may have a porosity in the range of 0.001≤p≤75%.

In yet another embodiment, a composite solid-state electrolyte membrane may be assembled into a solid-state battery.

In an aspect of the embodiment, a solid-state battery may be comprised of a composite cathode, a composite anode, and either a freestanding composite solid-state electrolyte membrane or one that is formed onto said composite cathode or composite anode structures.

In another aspect of the embodiment, a solid-state lithium metal battery may be comprised of a composite cathode, a lithium metal-based anode, and either a freestanding composite solid-state electrolyte membrane or one that is formed onto said composite cathode or lithium metal-based anode structures.

In yet another aspect of the embodiment, a solid-state anodeless battery may be comprised of a composite cathode, a negative current collector, and either a freestanding composite solid-state electrolyte membrane or one that is formed onto said composite cathode structure or negative current collector.

In yet another aspect of the embodiment, a solid-state battery, a solid-state lithium metal battery, or a solid-state anodeless battery, comprising of a meltblown composite solid-state electrolyte membrane, may include a small amount of liquid electrolyte to reduce cell impedance, what is commonly referred to in the art as a hybrid solid-state battery system.

In yet another embodiment, a composite solid-state electrolyte membrane may be assembled into an all-meltblown solid-state battery.

In an aspect of the embodiment, an all meltblown solid-state battery may be composed of a composite cathode, a composite anode, and a freestanding composite solid-state electrolyte membrane, wherein all three components are manufactured using a meltblown extrusion process.

In another aspect of the embodiment, a composite cathode may be composed of a single composite cathode membrane formed using meltblown extrusion. Alternatively, a composite cathode may be composed multiple composite cathode membranes, wherein the membranes are stacked on top of one another to form a composite cathode.

In yet another aspect of the embodiment, a composite cathode may be composed of multiple composite cathode membranes, wherein the membranes all have the same catholyte mass percentage relative to the active cathode and inactive material masses.

In yet another aspect of the embodiment, a composite cathode may be composed of multiple composite cathode membranes, wherein the membranes all have different catholyte mass percentages, relative to the active cathode and inactive material masses. In some instances, the composite cathode membranes may be stacked in such a way to form a catholyte gradient composite cathode structure, wherein the composite cathode membrane with the lowest catholyte mass percentage is in contact with the positive current collector, and the composite cathode membrane with the highest catholyte mass percentage is in contact with the composite solid-state electrolyte membrane.

In yet another aspect of the embodiment, a composite cathode membrane, may have a thickness is the range of 0.5≤t≤500 µm.

In yet another aspect of the embodiment, a composite cathode membrane may have a porosity in the range of 0.001≤p≤75%.

In another aspect of the embodiment, a composite anode may be composed of a single composite anode membrane formed using meltblown extrusion. Alternatively, a composite anode may be composed of multiple composite anode membranes, wherein the membranes are stacked on top of one another to form a composite anode.

In yet another aspect of the embodiment, a composite anode may be composed of multiple composite anode membranes, wherein the membranes all have the same anolyte mass percentage relative to the active anode and inactive material masses.

In yet another aspect of the embodiment, a composite anode may be composed of multiple composite anode membranes, wherein the membranes all have different anolyte mass percentages, relative to the active anode and inactive material masses. In some instances, the composite anode membranes may be stacked in such a way to form an anolyte gradient composite anode structure, wherein the composite anode membrane with the lowest anolyte mass percentage is in contact with the negative current collector, and the composite anode membrane with the highest anolyte mass percentage is in contact with the composite solid-state electrolyte membrane.

In yet another aspect of the embodiment, a composite anode membrane, may have a thickness is the range of 0.5≤t≤500 µm.

In yet another aspect of the embodiment, a composite anode membrane may have a porosity in the range of 0.001≤p≤75%.

The present disclosure relates to materials that make up a dry solid-state electrolyte composite formulation.

A dry solid-state electrolyte composite formulation may be composed of a solid-state ionic conductive material, a binding polymer, and ion conducting salt.

The present description relates to a solid-state ionic conductive material.

A composite solid-state electrolyte membranes includes or is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be > 10⁻⁷ S/cm. It is preferably to have lower electrical conductivity (≤ 10⁻⁷ S/cm).

Examples of the solid-state ionic conductive material include but not limited to a garnet-like structure oxide material with the general formula: [0075]

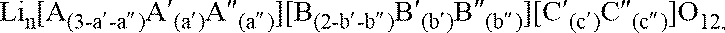

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤ 0.4; and
d. wherein n=7+a′+2·a″-b′-2·b″-3·c′-4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of LisOCl, Li₃OBr, Li₃OI.

In yet another example, a solid-state ionic conductive material includes Li₃YH₆(H═F, Cl, Br, I) family of materials, Y can be replaced by other trivalent elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻ Xₓ⁻, wherein M^{m+} ═ B³⁺, Ga³⁺, Sb³⁺, Si⁴⁺, Ge⁴⁺, P⁵⁺, As⁵⁺, or a combination thereof; Y^{2—} ═ O^{2—}, S²⁻, Se²⁻, Te²⁻, or a combination thereof; X^{—} ═ F^{—}, Cl⁻, Br⁻, I⁻, or a combination thereof; and x is in the range of 0 ≤ x ≤ 2.

In yet another example, a solid-state ionic conductive material includes argyrodites materials with the general formula: Li₁₈₋₂ₘ₋ₓM₂^{m}⁺Y₍₉₋ₓ₎₊ₙXₓ, wherein M^{m+} ═ B³⁺, Ga³⁺, Sb³⁺, Si⁴⁺, Ge⁴⁺, P⁵⁺, As⁵⁺, or a combination thereof; Y^{2—} ═ O^{2—}, S²⁻, Se²⁻, Te²⁻, or a combination thereof; X^{—} ═ F^{—}, Cl⁻, Br⁻, I⁻, or a combination thereof; and x is in the range of 0 ≤ x ≤ 2.

In yet another example, a solid-state ionic conductive material includes alkali metal halides with the general formula AₐM_{b}^{m+}M'_{b}^{,m'+}X_{a+mb+m'b'}, where A ═ Li⁺, Na⁺, K⁺, or a combination thereof, X^{—} ═ F^{—}, Cl⁻, Br⁻, I⁻, or a combination thereof, M^{m+} ═ Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺,V⁴⁺ Ti⁴⁺, Mo⁴⁺, W⁴⁺, V⁵⁺, Nb⁵⁺, Ta⁵⁺, Cr⁶⁺, Mo⁶⁺, W⁶⁺, etc., and M’^{m+} may be metal with the same valance state as M^{m+} when b′ is greater than 0, or an aliovalent substitution when b′ is greater than 0.

The present description relates to a binding polymer and an ionic conducting salt.

Binding polymers may be ionic conducting polymers or nonionic conducting polymers.

A binding polymer may include, for example, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(∈-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(∈-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

An ionic conducting salt may be mixed into a polymer matrix prior to a meltblown process.

Alternatively, ionic conducting salts may be added to a dry composite solid-state electrolyte powder formulation.

Ionic conducting salt may include, for example, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, etc.

Ionic conducting salts for non-lithium batteries may include, for example, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, , potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

The present disclosure relates to meltblown processing of the composite solid-state electrolyte membrane.

A meltblown process may be categorized as what is referred to in the art as an extrusion process.

A meltblown process may be an all dry or solvent-free processing approach.

A meltblown process may be used to manufacture freestanding composite solid-state electrolyte membranes.

Alternatively, a meltblown process may be used to manufacture composite solid-state electrolyte membranes onto a solid-state battery electrode.

A solid-state battery electrode may include, for example, a composite cathode, a composite anode, or a metal-based anode, such as lithium metal. In some instances, a negative current collector can play the role of a solid-state battery electrode within the meltblown process for solid-state anodeless type batteries.

A meltblown process may use a dry solid-state electrolyte composite formulation, consisting of solid-state ionic conductive materials, binding polymers, and an ionic conducting salt to form the composite solid-state electrolyte membrane.

The present description relates to a dry solid-state electrolyte composite formulation.

A dry solid-state electrolyte composite formulation may contain one, or a mixture of two or more, solid-state ionic conductive materials.

A solid-state ionic conductive material may be crystalline, glassy, or mixed phase.

A dry solid-state electrolyte composite formulation may contain one, or a mixture of two or more, binding polymers. Polymers may be in a solid form such as a particles, pellets, fibers, nanofibers, microfibers, nanoparticles, microparticles.

A dry solid-state electrolyte composite formulation may contain one, or a mixture of two or more, ionic conducting salts. In some instances, the ionic conducting salt can be integrated into a polymer matrix prior to the meltblown process.

A dry solid-state electrolyte composite formulation may contain solid-state ionic conductive material/binding polymer core shell structures, wherein solid-state ionic conductive materials are coated with a binding polymer prior a meltblown process.

Generally, a binding polymer is chemically compatible with the solid-state ionic conductive material. However, in some cases a solid-state ionic conductive material may chemically react with the binding polymer to enhance ionic conductivity.

A dry solid-state electrolyte composite formulation may have a solid-state ionic conductive material weight percentage in the range of 0.01≤p≤99.99%, with a preferred range of 25≤p≤99.9%.

A dry solid-state electrolyte composite formulation may have a solid-state ionic conductive material with a D50 particle size in the range of 0.01≤s≤500 µm, with a preferred range of 0.5≤s≤100 µm.

A dry solid-state electrolyte composite formulation may contain additives such as lithium nitrate or lithium bis(oxalato)borate to serve as of excess lithium source.

A dry solid-state electrolyte composite formulation may contain nonionic conductive additives inorganics such as alumina, titania, lanthanum oxide or zirconia.

The present description relates to the meltblown process.

A meltblown process may be done in a dry or inert environment.

A dry solid-state electrolyte composite formulation may be loaded into a hopper, wherein the hopper delivers the dry solid-state electrolyte composite formulation into an extruder.

A hopper may deliver the dry solid-state electrolyte composite formulation to the extrude continuously at a specified mass per unit of time. Alternatively, a hopper may deliver the dry solid-state electrolyte composite formulation to the extruder at specific intervals.

An extruder may be used to soften or melt the polymer within the solid-state composite formulation to form a slurry. In the art this may be referred to as a polymer melt.

An extruder may push the slurry into a gear pump which in turn pumps the slurry into a meltblown extrusion die, wherein it is extruded out in the form of a fiber stream.

A high-pressure inert gas may be used to push the slurry out of the die at high velocity.

An inert gas may include, for example, helium, nitrogen, argon, etc.

Alternatively, an inert gas may be substituted with hydrogen sulfide (H₂S) in the case of a sulfide-based solid-state ionic conductive material.

Alternatively, an inert gas may be substituted with oxygen in the case of a garnet-structure solid-state ionic conductive material.

An inert or substituted gas may be heated and blown into the meltblown extrusion die using a blower or blowing system.

The slurry may be extruded out of the die in the form of a fiber stream and collected onto a rotating collecting drum.

A rotating collecting drum may be temperature controlled. For example, a collecting drum can be heated using heating elements embedded in the drum. In another example, a collecting drum can be cooled using a water chilling system embedded in the drum.

A fiber stream may form a highly dense non-woven fibrous membrane (i.e. composite solid-state electrolyte membrane) on the collecting drum.

A free-standing composite solid-state electrolyte membrane may be rolled onto a winder and collected for further downstream processing.

Alternatively, a fiber stream may form a highly dense non-woven fibrous membrane (i.e. composite solid-state electrolyte membrane) onto a solid-state battery electrode, wherein a solid-state battery electrode (performed onto a current collector) is rolled onto a collecting drum prior to the formation of the composite solid-state electrolyte membrane.

A composite solid-state electrolyte membrane and the solid-state battery electrode may be rolled onto a winder and collector for further downstream processing.

Meltblown extrusion may be integrated into a roll-to-roll manufacturing process for solid-state batteries.

The structural architecture of the composite solid-state electrolyte membrane may be governed by the meltblown extrusion die.

The present description relates to processing aspects of the meltblown extrusion die.

A meltblown extrusion die may have one or more openings to extrude the slurry.

The one or more openings may control the diameter of the fibers within the dense non-woven fibrous membrane network.

The one or more openings may have a diameter in the range of 0.01≤d≤500 µm, with a preferred range of 0.1≤d≤25 µm.

The one or more openings may all have the same diameter. Alternative, the one or more opening may have various diameters to enhance membrane density.

The meltblown extrusion process may have one or more meltblown extrusion dies.

The one or more meltblown extrusion dies may have one more openings to extrude the slurry.

The one or more meltblown extrusion dies may all have the same number of openings. Alternatively, the one or more meltblown extrusion dies may vary in their number of openings.

The one or more meltblown extrusion dies may have one or more openings with the same diameter. Alternatively, the one or more meltblown extrusion dies may have one or more openings of various diameters.

The one or more meltblown extrusion dies may remain stationary.

Alternatively, the one or more meltblown extrusion dies may have a controlled or automated movement in the x-coordinate direction, y-coordinate direaction, z-coordinate direction, or a combination thereof to better control the density or architecture of the composite solid-state electrolyte membrane.

In an example, the one or more meltblown extrusion dies may move in a single x-coordinate direction, wherein they move back and forth in a raster formation with respect to the collecting drum, wherein the distance between said one or more meltblown extrusion dies and the collecting drum remains constant.

In another example, the one or more meltblown extrusion dies may move in a single y-coordinate direction, wherein they move up and down in a raster formation with respect to the collecting drum, wherein the distance between said one or more meltblown extrusion dies and the collecting drum remains constant.

In yet another example, the one or more meltblown extrusion dies may move in a single z-coordinate direction, wherein they move forward and back in a raster formation with respect to the collecting drum, wherein the distance between said one or more meltblown extrusion dies and the collecting drum various at a specified rate.

In yet another example, the one or more meltblown extrusion dies may move in the x-and y-coordinate direction, wherein they make clockwise or counterclockwise rotations respect to the collecting drum, wherein the distance between said one or more meltblown extrusion dies and the collecting drum remains constant. The one or more meltblown extrusion dies may switch back and forth between clockwise and counterclockwise rotations. Moreover, the one or more meltblown extrusion dies may all rotate the same direction or different directions at the same time.

In yet another example, the one or more meltblown extrusion dies may move in the x-and z-coordinate direction, wherein one or more meltblown extrusion dies move back and forth in a raster formation while at the same time varying the distance be it/them and the collecting drum at a specified rate.

In yet another example, the one or more meltblown extrusion dies may move in the y-and z-coordinate direction, wherein one or more meltblown extrusion dies move up and down

in a raster formation while at the same time varying the distance be it/them and the collecting drum at a specified rate.

In yet another example, the one or more meltblown extrusion dies may move in all three-coordinate direction, wherein the one or more meltblown extrusion make clockwise or counterclockwise rotations respect to the collecting drum while at the same time varying the distance be it/them and said collecting drum at a specified rate. This movement may also be described as a spiral like movement. The one or more meltblown extrusion dies may switch back and forth between clockwise and counterclockwise rotations. Moreover, the one or more meltblown extrusion dies may all rotate the same direction or different directions at the same time.

The present description relates to the composite solid-state electrolyte membrane formed from the meltblown process.

The composition of the composite solid-state electrolyte membrane may be controlled by the dry solid-state electrolyte composite formulation.

The composite solid-state electrolyte membrane may be mechanically flexible.

A composite solid-state electrolyte membrane may have a thickness in the range of, for example, 0.5≤t≤500 µm, with a preferred range of 1≤t≤100 µm.

The width of the composite solid-state electrolyte membrane may be governed by the meltblown extrusion process and the length of the collecting wheel, wherein the width is in the range of 1≤L≤5,000 cm, with a preferred range of 4≤L≤500 cm.

A composite solid-state electrolyte membrane may have a porosity in the range of, for example, 0.001≤p≤75%, with a preferred range of 0.001≤p≤15%, more preferably 0.001≤p≤5%, more preferably 0.001≤p≤1%.

A freestanding composite solid-state electrolyte membrane may be hot calendered or pressed downstream to decrease porosity.

A composite solid-state electrolyte membrane, formed onto a solid-state battery electrode, may be hot calendered or pressed downstream to decrease porosity.

In some instances, a solid-state battery electrode may be substituted with a fabric support, wherein a composite solid-state electrolyte is formed onto, and into, a fabric support.

In an example, a composite solid-state electrolyte membrane may be formed onto a fabric support is comprised of natural or synthetic fibers to enhance mechanical strength.

In other example, a composite solid-state electrolyte membrane may be formed onto metal-based fabric support in the form of a foam or mesh, wherein the metal-based fabric support can be heated to enhance ionic conductivity. A metal-based fabric support may be coated with an electronically insulative polymer or inorganic layer to prevent battery shorting.

Fabric supports may be heated using a variety of heating mechanisms such as, for example, resistive heating, induction heating, dielectric heating, etc.

Fabric supports may have a thickness in the range of, for example, 0.05≤t≤1000 µm, with a preferred range of 1≤t≤250 µm.

Composite solid-state electrolyte membranes may be formed onto one side of a fabric support and hot calendered or pressed. Alternatively, composite solid-state electrolyte membrane may be formed onto both sides of a fabric support and hot calendered or pressed.

Freestanding composite solid-state electrolyte membranes may be further processed downstream and integrated into solid-state battery assembly.

Composite solid-state electrolyte membranes with a fabric support may be further processed downstream and integrated into solid-state battery assembly.

Composite solid-state electrolyte membranes formed onto a solid-state battery electrode may be further processed downstream and integrated into solid-state battery assembly.

The present disclosure relates to solid-state battery electrodes.

A solid-state battery electrode may include, for example, a composite cathode, a composite anode, or a metal anode.

The present description relates to a composite cathode.

A composite cathode may be formed onto a positive current collector such as, for example, aluminum foil.

A composite cathode may be comprised of an active cathode material, inactive materials, and a catholyte.

Active materials may be coated with a protective layer serving as a solid electrolyte interface to enhance chemical stability with a catholyte.

Active cathode materials may include intercalation material such as, for example, layered YMO₂, Y-rich layered Y₁₊ₓM₁₋ₓO₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K, Mg, Zn, Al, etc.), vanadium oxides, sulfur, lithium sulfide, iron sulfide, FeF₃, LiSe.

In the case of a lithium intercalation, active cathode materials may include, for example, lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≧x≧0.5, 0.3≧y≧0.025, 0.2≧z≧0.025), lithium nickel cobalt aluminum oxide (LiNiₓCo_{y}Al_{z}O₂, 0.95≧x≧0.5, 0.3≧y≧0.025, 0.2≧z≧0.025), lithium nickel manganese spinel (LiNi_{0.5}Mn_{1.5}O₄), etc.

Active cathode materials may be single crystal, polycrystalline, or amorphous.

Active cathode materials may be coated with a protected layer to enhance chemical stability with a catholyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃) etc.

Inactive materials may include a binder such as, for example, polyvinylidene fluoride, polyacrylic acid, lotader, carboxymethyl cellulose, styrene-butadiene rubber, sodium alginate, etc.

An inactive material may include an electronically conductive additive such as, for example, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc.

An inactive material may include a metal binding material in the form of, for example, wires, fibers, nanofibers, nanowires, nanorods, microfibers, etc. that serves as an electronically conductive media.

An inactive material may include a small amount lithium additives such as lithium nitrate or lithium bis(oxalato)borate to serve as of excess lithium source.

A catholyte includes or is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be > 10⁻⁷ S/cm. It is preferably to have lower electrical conductivity (≤ 10⁻⁷ S/cm).

Examples of the solid-state ionic conductive material include but not limited to a garnet-like structure oxide material with the general formula: [0188]

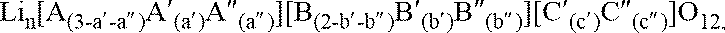

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤ 0.4; and
d. wherein n=7+a′+2·a″-b′-2·b″-3·c′-4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of LisOCl, Li₃OBr, Li₃OI.

In yet another example, a solid-state ionic conductive material includes Li₃YH₆(H ═ F, Cl, Br, I) family of materials, Y can be replaced by other trivalent elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻ Xₓ⁻, wherein M^{m+} ═ B³⁺, Ga³⁺, Sb³⁺, Si⁴⁺, Ge⁴⁺, P⁵⁺, As⁵⁺, or a combination thereof; Y^{2—} ═ O^{2—}, S²⁻, Se²⁻, Te²⁻, or a combination thereof; X^{—} ═ F^{—}, Cl⁻, Br⁻, I⁻, or a combination thereof; and x is in the range of 0 ≤ x ≤ 2.

In yet another example, a solid-state ionic conductive material includes argyrodites materials with the general formula: Li₁₈₋₂ₘ₋ₓM₂^{m}⁺Y₍₉₋ₓ₎₊ₙXₓ, wherein M^{m+} ═ B³⁺, Ga³⁺, Sb³⁺, Si⁴⁺, Ge⁴⁺, P⁵⁺, As⁵⁺, or a combination thereof; Y^{2—} ═ O^{2—}, S²⁻, Se²⁻, Te²⁻, or a combination thereof; X^{—} ═ F^{—}, Cl⁻, Br⁻, I⁻, or a combination thereof; and x is in the range of 0 ≤ x ≤ 2.

In yet another example, a solid-state ionic conductive material includes alkali metal halides with the general formula AₐM_{b}^{m+}M'_{b'}^{m'+}X_{a+mb+m'b'}, where A ═ Li⁺, Na⁺, K⁺, or a combination thereof, X^{—} ═ F^{—}, Cl⁻, Br⁻, I⁻, or a combination thereof, M^{m+} ═ Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺ Ti⁴⁺, Mo⁴⁺, W⁴⁺, V⁵⁺, Nb⁵⁺, Ta⁵⁺, Cr⁶⁺, Mo⁶⁺, W⁶⁺, etc., and M’^{m+} may be metal with the same valance state as M^{m+} when b′ is greater than 0, or an aliovalent substitution when b′ is greater than 0.

A catholyte material may be comprised of a mixture of two or more solid-state ionic conductive materials.

A catholyte material may be the same solid-state ionic conductive material that makes up the composite solid-state electrolyte membrane. Alternatively, a catholyte material is a different solid-state ionic conductive material.

The present description relates to a composite anode.

A composite anode may be formed onto a negative current collector such as, for example, copper foil or stainless steel.

A composite anode may be comprised of an active anode material, inactive materials, and an anolyte.

An active anode material may interact with ions through various mechanisms including, but not limited to, intercalation, alloying, plating, or conversion.

An active anode material in a may include, but not limited to, lithium powder, titanium oxide, silicon, tin oxide, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite’s, carbon nanofibers, carbon nanotubes, etc.), or a combination thereof.

In the case of lithium powder, alloying materials may be introduced into the composite anode structure which include, for example, tin, zinc, indium, magnesium, etc.

Active materials may be coated with a protective layer serving as a solid electrolyte interface to enhance chemical stability with an anolyte.

Protective coatings may include, for example, carbon, lithium niobate (LiNbO₃), lithium borate (Li₂B₄O₇), lithium zirconate (Li₂ZrO₂), lithium titanate (Li₄Ti₅O₁₂), aluminum oxide (Al₂O₃) etc.

Inactive materials may include a binder such as, for example, polyvinylidene fluoride, polyacrylic acid, lotader, carboxymethyl cellulose, styrene-butadiene rubber, sodium alginate, etc.

An inactive material may include an electronically conductive additive such as, for example, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc.

An inactive material may include a metal binding material in the form of, for example, wires, fibers, nanofibers, nanowires, nanorods, microfibers, etc. that serves as an electronically conductive media.

An inactive material may include a small amount lithium additives such as lithium nitrate or lithium bis(oxalato)borate to serve as of excess lithium source.

An anolyte includes or is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be > 10⁻⁷ S/cm. It is preferably to have lower electrical conductivity (≤ 10⁻⁷ S/cm).

Examples of the solid-state ionic conductive material include but not limited to a garnet-like structure oxide material with the general formula: [0221]

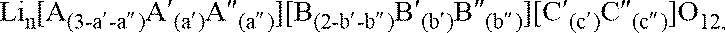

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤ 0.4; and
d. wherein n=7+a′+2·a″-b′-2·b″-3·c′-4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of LisOCl, Li₃OBr, Li₃OI.

In yet another example, a solid-state ionic conductive material includes Li₃YH₆(H ═ F, Cl, Br, I) family of materials, Y can be replaced by other trivalent elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻ Xₓ⁻, wherein M^{m+} ═ B³⁺, Ga³⁺, Sb³⁺, Si⁴⁺, Ge⁴⁺, P⁵⁺, As⁵⁺, or a combination thereof; Y^{2—} ═ O^{2—}, S²⁻, Se²⁻, Te²⁻, or a combination thereof; X^{—} ═ F^{—}, Cl⁻, Br⁻, I⁻, or a combination thereof; and x is in the range of 0 ≤ x ≤ 2.

In yet another example, a solid-state ionic conductive material includes argyrodites materials with the general formula: Li₁₈₋₂ₘ₋ₓM₂^{m}⁺Y₍₉₋ₓ₎₊ₙXₓ, wherein M^{m+} ═ B³⁺, Ga³⁺, Sb³⁺, Si⁴⁺, Ge⁴⁺, P⁵⁺, As⁵⁺, or a combination thereof; Y^{2—} ═ O^{2—}, S²⁻, Se²⁻, Te²⁻, or a combination thereof; X^{—} ═ F^{—}, Cl⁻, Br⁻, I⁻, or a combination thereof; and x is in the range of 0 ≤ x ≤ 2.

In yet another example, a solid-state ionic conductive material includes alkali metal halides with the general formula AₐM_{b}^{m+}M'_{b'}^{m'+}X_{a+mb+m'b'}, where A ═ Li⁺, Na⁺, K⁺, or a combination thereof, X^{—} ═ F^{—}, Cl⁻, Br⁻, I⁻, or a combination thereof, M^{m+} ═ Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺,V⁴⁺ Ti⁴⁺, Mo⁴⁺, W⁴⁺, V⁵⁺, Nb⁵⁺, Ta⁵⁺, Cr⁶⁺, Mo⁶⁺, W⁶⁺, etc., and M’^{m+} may be metal with the same valance state as M^{m+} when b′ is greater than 0, or an aliovalent substitution when b′ is greater than 0.

An anolyte material may be comprised of a mixture of two or more solid-state ionic conductive materials.

An anolyte material may be the same solid-state ionic conductive material that makes up the composite solid-state electrolyte membrane. Alternatively, an anolyte material is a different solid-state ionic conductive material.

The present description relates to a metal anode.

A metal anode may be laminated onto a negative current collector.

A metal anode may include, for example, a lithium-metal or a lithium metal-alloy film. Non-lithium batteries may include, for example, sodium, magnesium, potassium, etc.

An alloy may include, for example, indium, tin, zinc, manganese, silicon, etc.

A metal anode may be in the form of a uniform film. Alternatively, a metal anode may be in a patterned onto the negative current collector.

A metal anode may be coated with a protective layer such as LiPON or carbon serving as a protective layer to enhance battery performance. This protective layer may be referred to in the art as an artificial solid electrolyte interface.

The present disclosure relates to a solid-state battery.

A solid-state battery may be comprised of a composite cathode and a composite anode, separated by a composite solid-state electrolyte membrane, wherein a composite cathode is formed onto a positive current collector, such as aluminum, and a composite anode is formed onto a negative current collector, such as copper.

A composite solid-state electrolyte membrane in a solid-state battery may be freestanding (including those with a fabric support embedded within), formed onto a composite cathode, or formed onto a composite anode.

A solid-state lithium metal battery may be comprised of a composite cathode and a lithium metal-based anode, separated by a composite solid-state electrolyte membrane, wherein a composite cathode is formed onto a positive current collector, such as aluminum, and a lithium metal-based anode formed onto a negative current collector, such as copper.

A composite solid-state electrolyte membrane in a solid-state lithium metal battery may be freestanding (including those with a fabric support embedded within), formed onto a composite cathode, or formed onto a lithium-metal based anode.

A solid-state anodeless battery may be comprised of a composite cathode and a negative current collector, separated by a composite solid-state electrolyte membrane, wherein a composite cathode is formed onto a positive current collector, such as aluminum, and the negative current collector is composed of, for example, copper.

A composite solid-state electrolyte membrane in an anodeless solid-state battery may be freestanding (including those with a fabric support embedded within), formed onto a composite cathode, or formed onto a negative current collector.

A solid-state battery may further comprise of a small amount of liquid electrolyte at the composite solid-state electrolyte membrane and electrode interface to reduce cell impedance. Such cells may be referred to in the art as hybrid cells.

Liquids may include, for example, room temperature ionic liquid electrolytes or organic-based liquid electrolytes.

The present disclosure relates to an all-meltblown solid-state battery structure.

An all-meltblown solid-state battery structure may include a composite cathode membrane, a composite anode membrane, as well as the composite solid-state electrolyte membrane (including those with a fabric support embedded within), and all formed using the aforementioned meltblown process.

A dry composite cathode powder formulation may be used to form a freestanding composite cathode membrane. Alternatively, a composite cathode membrane may be formed onto a positive current collector.

A dry composite cathode formulation may contain, for example, an active cathode material, with or without a protective coating, a catholyte, and inactive components such as a binding polymer and an electronically conductive additive.

A composite cathode may be comprised of a single composite cathode membrane.

A composite cathode membrane may have a thickness in the range of, for example, 0.5≤t≤500 µm, with a preferred range of 1≤t≤100 µm.

The width of the composite cathode membrane may be governed by the meltblown extrusion process and the length of the collecting wheel, wherein the width is in the range of 1≤L≤5,000 cm, with a preferred range of 4≤L≤500 cm.

A composite cathode membrane may have a porosity in the range of, for example, 0.001≤p≤75%, with a preferred range of 0.001≤p≤15%, more preferably 0.001≤p≤5%, more preferably 0.001≤p≤1%.

Alternatively, a composite cathode may be comprised of more than one composite cathode membranes all with the same catholyte mass percentage, relative to the total mass of the active cathode materials and inactive materials.

In the instance that a composite cathode is comprised of more than one composite cathode membrane, the membranes may have varying catholyte mass percentages, relative to the total mass of the active cathode materials and inactive materials.

In an example, a composite cathode may be comprised of three or more composite cathode membranes, wherein the membranes all have a different catholyte mass percentage forming a catholyte gradient composite cathode structure. A first composite cathode membrane, formed or laminated onto a positive current collector, may have a low catholyte mass percentage in the range of 70≤p≤0.01%, with a preferred range of 30≤p≤0.1%. A second composite cathode membrane, formed onto the first composite cathode membrane, may have a higher catholyte mass percentage than the first membrane and in the range of 75≤p≤0.05%, with a preferred range of 35≤p≤0.5%. A third composite cathode membrane, formed onto a second composite cathode membrane, may have a higher catholyte mass percentage than the second membrane and in the range of 80≤p≤0.1%, with a preferred range of 40≤p≤1.0%. Additional composite cathode membranes may be formed, wherein each subsequent membrane has a higher catholyte mass percentage than the previous membrane.

A dry composite anode powder formulation is used to form a freestanding composite anode membrane. Alternatively, a composite anode membrane may be formed onto a negative current collector.

A dry composite anode formulation may contain, for example, an active anode material, with or without a protective coating, an anolyte, and inactive components such as a binding polymer and an electronically conductive additive.

A composite anode may be comprised of a single composite anode membrane.

A composite anode membrane may have a thickness in the range of, for example, 0.5≤t≤500 µm, with a preferred range of 1≤t≤100 µm.

The width of the composite anode membrane may be governed by the meltblown extrusion process and the length of the collecting wheel, wherein the width is in the range of 1≤L≤5,000 cm, with a preferred range of 4≤L≤500 cm.

A composite anode membrane may have a porosity in the range of, for example, 0.001≤p≤75%, with a preferred range of 0.001≤p≤15%, more preferably 0.001≤p≤5%, more preferably 0.001≤p≤1%.

Alternatively, a composite anode may be comprised of more than one composite anode membrane, wherein the membranes all with the same anolyte mass percentage relative to the total mass of the active anode materials and inactive materials.

In the instance that a composite anode is comprised of more than one composite anode membrane, the membranes may have different anolyte mass percentages, relative to the total mass of the active anode materials and inactive materials.

In an example, a composite anode may be comprised of three or more composite anode membranes, wherein the membranes all have a different anolyte mass percentage forming an anolyte gradient composite anode structure. A first composite anode membrane, formed or laminated onto a negative current collector, may have a low anolyte mass percentage in the range of 70≤p≤0.01%, with a preferred range of 30≤p≤0.1%. A second composite anode membrane, formed onto the first composite anode membrane, may have a higher anolyte mass percentage than the first membrane and in the range of 75≤p≤0.05%, with a preferred range of 35≤p≤0.5%. A third composite anode membrane, formed onto a second composite anode membrane, may have a higher anolyte mass percentage than the second membrane and in the range of 80≤p≤0.1%, with a preferred range of 40≤p≤1.0%. Additional composite anode membranes may be formed, wherein each subsequent membrane has a higher anolyte mass percentage than the previous membrane.

An all-meltblown solid-state battery structure may include, for example, a single composite cathode membrane, and a single composite anode membrane, separated by a composite solid-state electrolyte membrane.

An all-meltblown solid-state battery structure may include, for example, a composite cathode, comprising of more than one composite cathode membranes all with the same or varying catholyte mass percentages, and single composite anode membrane, separated by a composite solid-state electrolyte membrane.

An all-meltblown solid-state battery structure may include, for example, a single composite cathode membrane, and a composite anode, comprising of more than one composite anode membranes all with the same or varying anolyte mass percentages, separated by a composite solid-state electrolyte membrane.

An all-meltblown solid-state battery structure may include, for example, a composite cathode, comprising of more than one composite cathode membranes all with the same or varying catholyte mass percentage, and a composite anode, comprising of more than one composite anode membranes all with the same or varying anolyte mass percentages, separated by a composite solid-state electrolyte membrane.

An all-meltblown solid-state battery structure may include, for example, a composite cathode, comprising of three or more composite cathode membranes in the form of a catholyte gradient composite cathode structure. In this example, a composite anode may comprise of either a single composite anode membrane, more than one composite anode membranes all with the same or varying anolyte mass percentages, or more than three composite anode membranes in the form of an anolyte gradient composite anode structure. Composite cathode and composite anode structures may be separated by a composite solid-state electrolyte membrane.

An all-meltblown solid-state battery structure may include, for example, a composite anode, comprising of three or more composite anode membranes in the form of an anolyte gradient composite anode structure. In this example, a composite cathode may comprise of either a single composite cathode membrane, more than one composite cathode membranes all with the same or varying catholyte mass percentage, or more than three composite cathode membranes in the form of a catholyte gradient composite cathode structure. Composite cathode and composite anode structures may be separated by a composite solid-state electrolyte membrane.

An all-meltblown solid-state battery structure may include, for example, a composite cathode, comprising of either a single composite cathode membrane, more than one composite cathode membranes all with the same or varying catholyte mass percentages, or more than three composite cathode membranes in the form of a catholyte gradient composite cathode structure. In this example, a solid-state battery has lithium-metal based anode and a composite solid-state electrolyte membrane, forming a solid-state lithium metal battery.

An all-meltblown solid-state battery structure may include, for example, a composite cathode, comprising of either a single composite cathode membrane, more than one composite cathode membranes all with the same or varying catholyte mass percentages, or more than three composite cathode membranes in the form of a catholyte gradient composite cathode structure. In this example, a solid-state battery has no anode and a composite solid-state electrolyte membrane, forming an anodeless solid-state battery structure.

An all-meltblown solid-state battery structure may further comprise of a small amount of liquid electrolyte at the composite solid-state electrolyte membrane and electrode interface to reduce cell impedance. Such cells may be referred to in the art as hybrid cells.

Liquids may include, for example, room temperature ionic liquid electrolytes or organic-based liquid electrolytes.

Drawings of the present disclosure further describes examples of meltblown processing of composite solid-state electrolyte membranes.

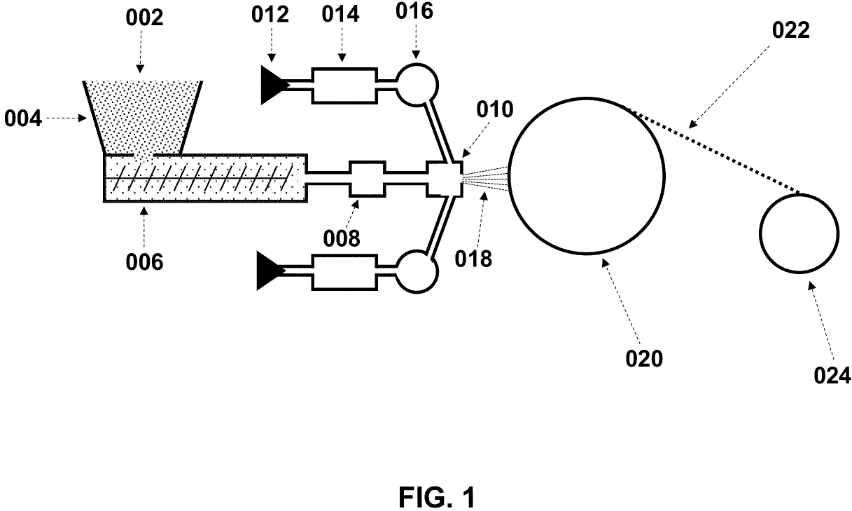

FIG. 1: A schematic illustration of a meltblown extrusion process for the manufacturing of freestanding composite solid-state electrolyte membranes. A dry solid-state electrolyte composite formulation (002) is loaded into a hopper (004) and fed into an extruder (006). The polymer component of the dry solid-state electrolyte composite formulation (002) is softened within the extruder forming a slurry. The slurry is pushed into a gear pump (008) which in turn pumps the slurry into a die (010) to be extruded out in the form of a fiber stream (018). A high pressure inter gas (012) is heated (014) and blown (016) into the die (010), pushing the fiber stream (018) out at a high velocity. The fiber stream (018) is collected onto a rotating collecting drum (020), forming a highly dense non-woven composite solid-state electrolyte membrane (022). The composite solid-state electrolyte membrane (022) is collected onto a winder (024) and further processed downstream.

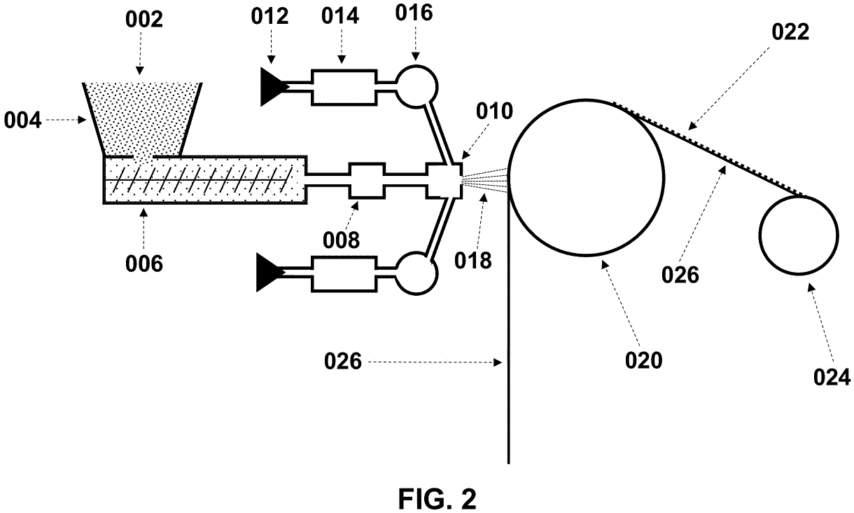

FIG. 2: A schematic illustration of a meltblown extrusion process for the manufacturing of composite solid-state electrolyte membranes onto solid-state battery electrodes. A dry solid-state electrolyte composite formulation (002) is loaded into a hopper (004) and fed into an extruder (006). The polymer component of the dry solid-state electrolyte composite formulation (002) is softened within the extruder forming a slurry. The slurry is pushed into a gear pump (008) which in turn pumps the slurry into a die (010) to be extruded out in the form of a fiber stream (018). A high pressure inter gas (012) is heated (014) and blown (016) into the die (010), pushing the fiber stream (018) out at a high velocity. A solid-state battery electrode (026), composed of a battery electrode formed onto a current collector, is rolled along a rotating collecting drum (020). The fiber stream (018) is collected onto the rolling solid-state battery electrode (026), forming a highly dense non-woven composite solid-state electrolyte membrane (022). The composite solid-state electrolyte membrane (022), formed onto the solid-state battery electrode (026), is collected on a winder (024) and further processed downstream.

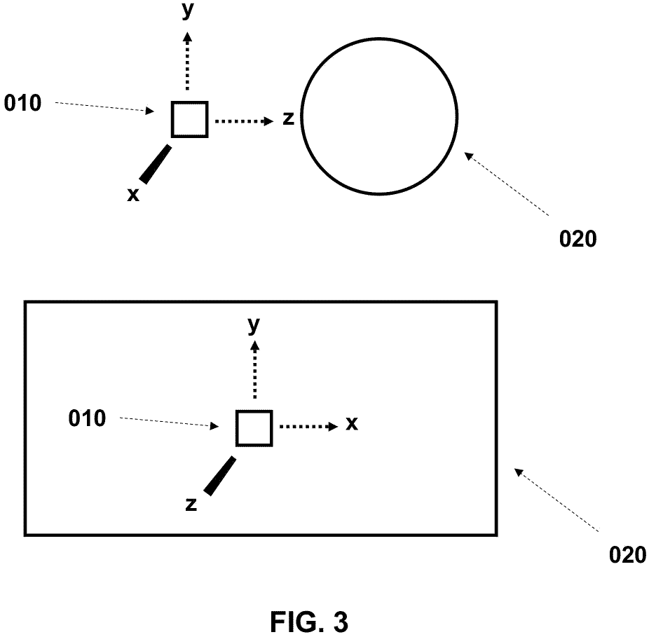

FIG. 3: A schematic illustration of the x, y, and z coordinate relationship between the meltblown extrusion die (010) and the collecting drum (020), and as it relates to the movement of the meltblown extrusion die (010). Top schematic is a side view of the meltblown extrusion process. The bottom schematic is a top view of the meltblown extrusion process.

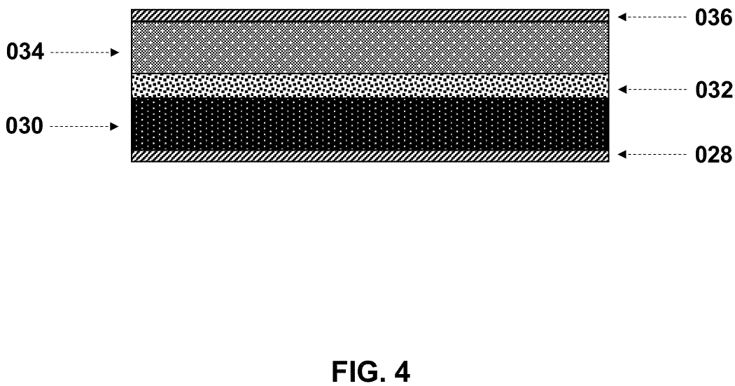

FIG. 4: A schematic illustration of a solid-state battery with a composite cathode (030), formed onto a positive current collector (028), and a composite anode (034), formed onto a negative current collector (036), wherein a freestanding composite solid-state electrolyte membrane (032) separates the composite cathode (030) and composite anode (034), forming a solid-state battery.

Alternatively, the schematic illustration in FIG. 4 may be a solid-state battery with a composite cathode (030), formed onto a positive current collector (028), and a composite anode (034), formed onto a negative current collector (036), wherein a composite solid-state electrolyte membrane (032) is formed onto the composite cathode (030) and then assembled with the composite anode (034) downstream to form a solid-state battery.

Alternatively, the schematic illustration in FIG. 4 may be a solid-state battery with a composite cathode (030), formed onto a positive current collector (028), and a composite anode (034), formed onto a negative current collector (036), wherein a composite solid-state electrolyte membrane (032) is formed onto the composite anode (034) and then assembled with the composite cathode (030) downstream to form a solid-state battery.

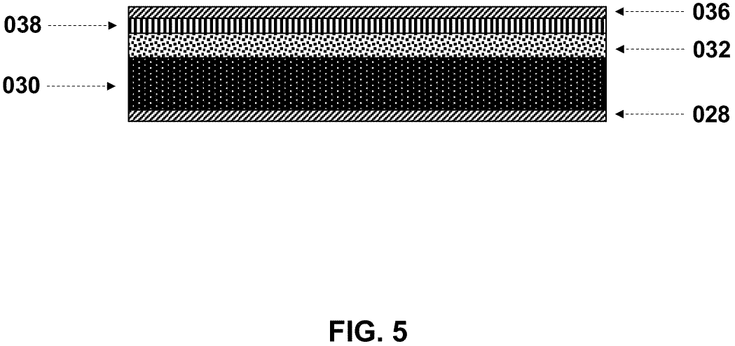

FIG. 5: A schematic illustration of a solid-state lithium metal battery with a composite cathode (030), formed onto a positive current collector (028), and a lithium metal anode (038), formed onto a negative current collector (036), wherein a freestanding composite solid-state electrolyte membrane (032) separates the composite cathode (030) and lithium metal anode (038), forming a solid-state lithium metal battery.

Alternatively, the schematic illustration in FIG. 5 may be a solid-state lithium metal battery with a composite cathode (030), formed onto a positive current collector (028), and a lithium metal anode (038), formed onto a negative current collector (036), wherein a composite solid-state electrolyte membrane (032) is formed onto the composite cathode (030) and then assembled with the lithium metal anode (038) downstream to form a solid-state lithium metal battery.

Alternatively, the schematic illustration in FIG. 5 may be a solid-state lithium metal battery with a composite cathode (030), formed onto a positive current collector (028), and a lithium metal anode (038), formed onto a negative current collector (036), wherein a composite solid-state electrolyte membrane (032) is formed onto the lithium metal anode (038) and then assembled with the composite cathode (030) downstream to form a solid-state lithium metal battery.

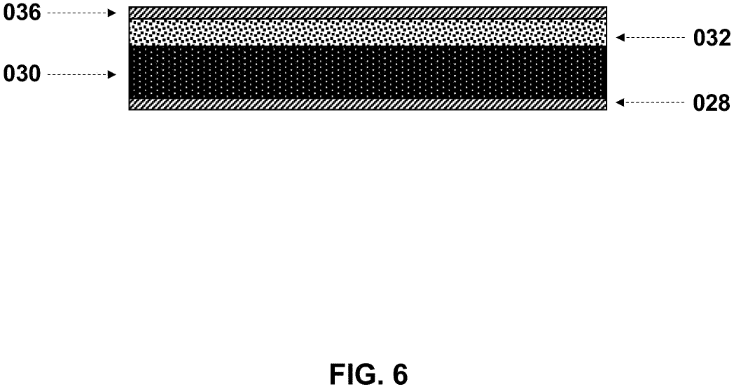

FIG. 6: A schematic illustration of a solid-state anodeless battery with a composite cathode (030), formed onto a positive current collector (028), and a negative current collector (036), wherein a freestanding composite solid-state electrolyte membrane (032) separates the composite cathode (030) and negative current collector (036), forming a solid-state anodeless battery.

Alternatively, the schematic illustration in FIG. 6 may be a solid-state anodeless battery with a composite cathode (030), formed onto a positive current collector (028), and a negative current collector (036), wherein a composite solid-state electrolyte membrane (032) is formed onto the composite cathode (030) and then assembled with the negative current collector (036) downstream to form a solid-state anodeless battery.

Alternatively, the schematic illustration in FIG. 6 may be a solid-state anodeless battery with a composite cathode (030), formed onto a positive current collector (028), and a negative current collector (036), wherein a composite solid-state electrolyte membrane (032) is formed onto the negative current collector (036) and then assembled with the composite cathode (030) downstream to form a solid-state anodeless battery.

The above-described systems and methods can be ascribed to lithium-based secondary batteries such as, but not limited to, lithium-ion batteries, lithium metal batteries, all-solid-state lithium batteries, aqueous batteries, lithium polymer batteries, etc.

The above-described systems and methods can be ascribed to secondary batteries with chemistries beyond lithium, which may include sodium ion, aluminum ion, magnesium ion, iron ion, potassium ion, etc.

The above-described systems and methods can be ascribed to various secondary battery designs such as, but not limited to, pouch cell, coil cell, button cell, cylindrical cell, prismatic cell, etc.

The above-described systems and methods can be ascribed to secondary batteries with the end use applications such as, but not limited to, electric vehicles, hybrid electric vehicles, mobile devices, handheld electronics, consumer electronics, medical, medical wearables, and wearables for portable energy storage.

The above-described systems and methods can be ascribed to secondary batteries for grid scale energy storage backup systems.

The above-described systems and methods can be ascribed to secondary batteries for longevity, higher energy density and power density and improved safety.

The above-described systems and methods can be ascribed for alternative energy storage technologies such as primary batteries and flow batteries.

In the drawings, the following reference numbers are noted:
002 Dry composite solid-state electrolyte formulation
004 Hopper
006 Extruder
008 Gear pump
010 Meltblown extrusion die
012 Inert gas
014 Heater
016 Blower
018 Fiber stream
020 Collecting drum
022 Freestanding composite solid-state electrolyte membrane
024 Winder
026 Solid-state battery electrode
028 Positive current collector
030 Composite cathode
032 Composite solid-state electrolyte membrane
034 Composite anode
036 Negative current collector
038 Lithium metal anode

Although various embodiments of the disclosed methods for manufacturing a composite solid-state electrolyte membrane, methods for manufacturing a solid-state battery, and solid-state batteries comprising a composite solid-state electrolyte membrane have been shown and described, modifications may occur to those skilled in the art upon reading the specification. The present application includes such modifications and is limited only by the scope of the claims.

What is claimed is:

1. A method for manufacturing a composite solid-state electrolyte membrane, the method comprising:
forming the composite solid-state electrolyte membrane by meltblown extrusion.

2. The method of claim 1, wherein forming the composite solid-state electrolyte membrane by meltblown extrusion comprises:
forming the composite solid-state electrolyte membrane by meltblown extrusion on a substrate; and
separating the composite solid-state electrolyte membrane from the substrate.

3. The method of claim 2, wherein the substrate is a rotating collecting drum.

4. The method of claim 1, wherein forming the composite solid-state electrolyte membrane by meltblown extrusion comprises forming the composite solid-state electrolyte membrane by meltblown extrusion on a solid-state battery electrode.

5. The method of claim 1, wherein forming the composite solid-state electrolyte membrane by meltblown extrusion comprises forming the composite solid-state electrolyte membrane by meltblown extrusion on a support.

6. The method of claim 5, the support is a fabric support.

7. The method of claim 1, wherein forming the composite solid-state electrolyte membrane by meltblown extrusion comprises forming the composite solid-state electrolyte membrane by meltblown extrusion into a porous support.

8. A method for manufacturing a solid state battery, the method comprising:
forming a composite solid-state electrolyte membrane by meltblown extrusion; and
positioning the composite solid-state electrolyte membrane between a positive current collector and a negative current collector.

9. The method of claim 8, further comprising forming an anode by meltblown extrusion with the composite solid-state electrolyte membrane.

10. The method of claim 8, further comprising forming a cathode by meltblown extrusion with the composite solid-state electrolyte membrane.

11. The method of claim 8, further comprising forming an anode and then assembling the anode with the composite solid-state electrolyte membrane into the solid state battery.

12. The method of claim 8, further comprising forming a cathode and then assembling the cathode with the composite solid-state electrolyte membrane into the solid state battery.

13. A solid state battery, comprising:
a positive current collector;
a negative current collector; and
a composite solid-state electrolyte membrane between the positive current collector and negative current collector, the composite solid-state electrolyte membrane having a meltblown structure.

14. The solid state battery of claim 13, further comprising an anode between the negative current collector and the composite solid-state electrolyte membrane.

15. The solid state battery of claim 14, wherein the anode has a meltblown structure.

16. The solid state battery of claim 13, further comprising an cathode between the positive current collector and the composite solid-state electrolyte membrane.

17. The solid state battery of claim 16, wherein the cathode has a meltblown structure.
